(19) United States
(12) Patent Application Publication
(10) Pub. No.: US 2008/0018603 A1
(43) Pub. Date: Jan. 24, 2008

(54) USER INTERFACE SYSTEM

(75) Inventors: Benjamin Baraz, Kfar-Saba (IL); Yona Newman, Ra-anana (IL)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Plantation, FL (US)

(21) Appl. No.: 11/459,516

(22) Filed: Jul. 24, 2006

(51) Int. Cl. G09G 5/00

(52) U.S. Cl. 345/168

(57) ABSTRACT

A user interface system (102) for a portable electronic device (100) is disclosed. The user interface system includes an interface (202) that is made of a flexible material and has an active position and an inactive position. The interface is coupled with a reservoir (204). The reservoir is used for storing electrorheological fluid (206). The user interface system also includes a source (208) that is coupled to the reservoir. The source is used for applying an electric field to the electrorheological fluid when the interface is in the active position.

### FIELD OF THE INVENTION

The invention relates in general to the field of portable electronic devices, and more particularly, to a user interface system for a portable electronic device.

### BACKGROUND OF THE INVENTION

Nowadays, electronic devices, for example, a mobile telephone, a personal digital assistant (PDA), a laptop computer and/or a smart telephone, are becoming increasingly popular. An electronic device generally has a user interface system, which facilitates user interaction with the electronic device. The user interface system, such as a keyboard, a keypad and a touch screen, can be used to input data to the electronic device or provide commands to the electronic device. Further, the user interface system, such as a Liquid Crystal Display (LCD), an electronic (E) paper, and a touch screen, can be used to display information. These user interface systems tend to be bulky and inflexible, causing inconvenience in portability and problems in handling.

Currently, there exist various user interface systems, which are portable to a certain degree. In one such user interface system, various components of the user interface system can be disassembled and assembled whenever required. However, such a user interface system requires manual effort to assemble and disassemble that can be time-consuming and tiresome. Further, the user interface system becomes bulky after being re-assembled. Moreover, this user interface system may not facilitate portability since it might not be convenient for a user to disassemble and assemble the system frequently.

In view of the foregoing discussion, there exists a need for a user interface system which occupies the minimum amount of workspace and is easy to carry as well.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments as well as explain various principles and advantages, all in accordance with the present invention.

FIG. 1 illustrates an exemplary portable electronic device, in accordance with an embodiment of the present invention;

FIG. 2 illustrates a top view of a user interface system, in accordance with an embodiment of the present invention;

FIG. 3 illustrates a side view of the user interface system, in accordance with an embodiment of the present invention;

FIG. 4 illustrates a front view of a user interface system, in accordance with another embodiment of the present invention;

FIG. 5 is a flow diagram illustrating a method for operating the user interface system, in accordance with an embodiment of the present invention; and

FIG. 6 illustrates a rolled-up view of a user interface system, in accordance with an embodiment of the present invention.

### DETAILED DESCRIPTION

In an embodiment, a user interface system is provided. The user interface system includes an interface, a reservoir and a source. The interface is made of flexible material. The interface has an active position and an inactive position. Further, the interface is coupled to the reservoir, which stores an electrorheological fluid. Moreover, the source is also coupled to the reservoir. The source can apply an electric field to the electrorheological fluid, making the interface rigid when in the active position.

In another embodiment, a method for operating a user interface system is provided. The method includes coupling a reservoir to the user interface system. The reservoir stores an electrorheological fluid. The method further includes maintaining the user interface system in an inactive position. When an activation of the user interface system is detected the electric field is applied to the electrorheological fluid. As a result, the electrorheological fluid changes its physical state from a liquid to a semi-solid state. Thereafter, the user interface system is operated in an active position.

Before describing in detail the particular user interface system, in accordance with various embodiments of the present invention, it should be observed that the present invention resides primarily in combinations of apparatus components and method steps related to a user interface system. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms “comprises,” “comprising,” or any other variation thereof, are intended to cover a non-exclusive inclusion, such that a process, method, article or apparatus that comprises a list of elements does not include only those elements but may include other elements not expressly listed or inherent to such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The term “includes,” as used herein, is defined as comprising.

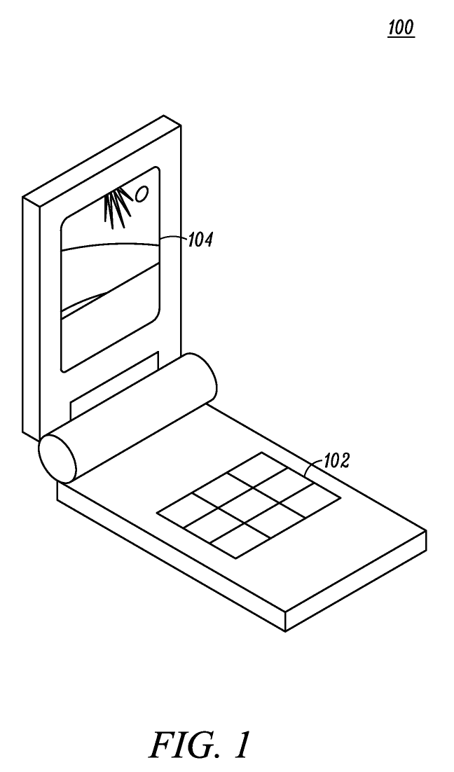

FIG. 1 illustrates an exemplary portable electronic device 100, in accordance with an embodiment of the present invention. Examples of the portable electronic device 100 include, but are not limited to, a mobile telephone, a smart telephone, a laptop computer, a desktop computer and a personal digital assistant (PDA). The portable electronic device 100 includes user interface systems 102 and 104. In the FIG. 1, the user interface systems 102 and 104 are shown as a keypad and a display of a mobile phone respectively. An input is provided to the portable electronic device 100 through the user interface systems 102 (shown as a keypad). It will be appreciated that the input to the portable electronic device 100 can be entered using any other user interface system such as a touch screen. Thereafter, based on the input, information is displayed on the user interface systems 104 (shown as a display). It should be noted that the invention can be implemented for other suitable user interface system such as a flexible key matrix, an electronic (E) paper, and a touch screen.

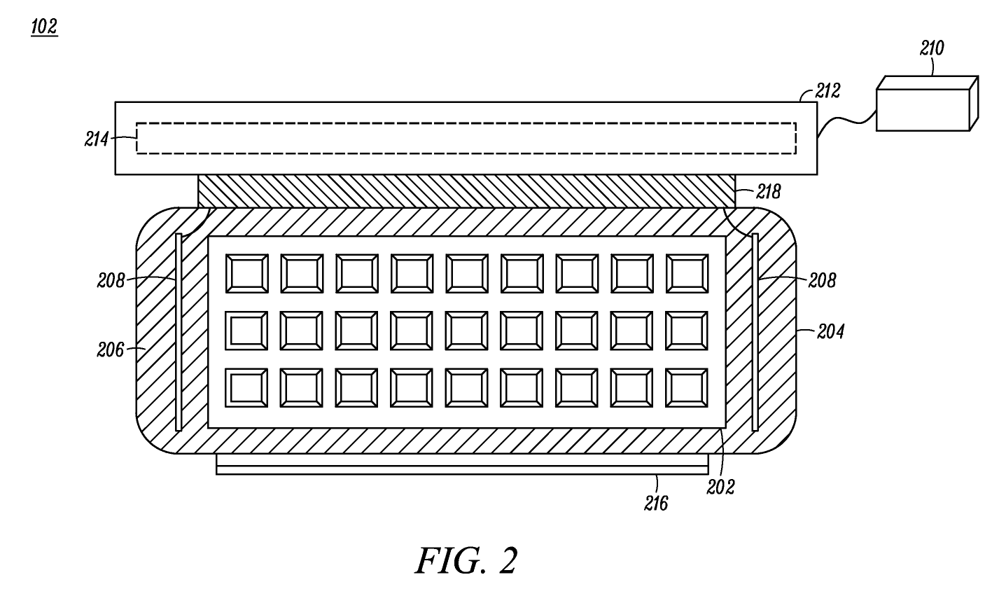

FIG. 2 illustrates a top view of the user interface system 102 (shown as a keypad in FIG. 1), in accordance with an embodiment of the present invention. In this figure, the user interface system 102 is represented as a keypad. Hereinafter, in this figure, the user interface system 102 is referred to as the keypad. The keypad includes an interface 202, a reservoir 204, an electrorheological fluid 206, and a source 208. The keypad also includes a portable power unit 210, an enclosure 212, a reservoir enclosure 214, a handle 216, and a strip 218. The interface 202 is made of a flexible and rollable material such as silicon-based materials, rubber, plastic, and so forth. Examples of the interface 202 include, but are not limited to, a key matrix, and a projector screen. The interface 202 is coupled to the reservoir 204. In an embodiment, the interface 202 is attached or fixed at the top of the reservoir 204. The reservoir 204 can be made up of a flexible material such as plastic, silicon, rubber, and so forth. The reservoir 204 can store the electrorheological fluid 206 in it. The electrorheological fluid 206, such as lithium polymethacrylate, changes from a liquid state to a semi-solid (or solid) state due to change in its viscosity, when the electric field is applied to it. For example, when the electric field is applied to lithium polymethacrylate, its viscosity increases by ‘10⁵’ times.

As a result, the interface 202 and the reservoir 204 become rigid; this position being referred to as an active position of the interface 202 and the user interface system 102. In FIG. 2, the user interface system 102 is shown in the active position.

The electric field can be applied to the electrorheological fluid 206 through the source 208. The source 208 can be a plurality of electrodes, shown in FIG. 2. The source 208 can be made of flexible materials such as copper, silver, aluminum, gold, gold plated/flashed over nickel, and so forth. In an embodiment, the electric field can be applied through the source 208 using the portable power unit 210 such as a portable battery. The portable power unit 210 may be an AC battery or a DC battery.

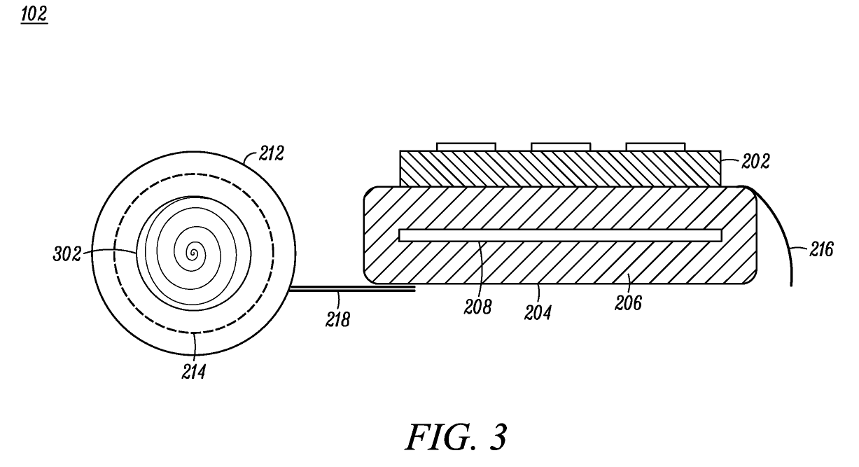

Further, when the electric field is removed from the electrorheological fluid 206, the viscosity reduces and electrorheological fluid 206 again reverts to a liquid state. As a result, the interface 202 and the reservoir 204 become flexible again. In an embodiment, the interface 202 and the reservoir 204 are coiled and enclosed in the enclosure 212. In an embodiment, the reservoir 204 is enclosed in the reservoir enclosure 214. Such a position is referred to as an inactive position of the interface 202 and the user interface system 102. In an embodiment, a spring, not shown in FIG. 2, can be used to enable coiling of the interface 202 and the reservoir 204 in the enclosure 212. The spring is explained in detail in conjunction with FIG. 3.

In an embodiment, the handle 216 is attached to the reservoir 204. The handle 216 facilitates uncoiling of the interface 202, along with the reservoir 204, from the inactive position. In other words, the interface 202 is pulled with the help of the handle 216. This enables uncoiling of the interface 202 and the reservoir 204.

In an embodiment, the strip 218 connects the reservoir 204 to the enclosure 212. In another embodiment, the strip 218 connects the interface 202 to the enclosure 212. In yet another embodiment, the strip 218 connects the reservoir 204 and the interface 202 to the enclosure 212. The strip 218 can be made of electrically conducting sections such as a copper section, a silver section, and so forth. In an embodiment, the conducting sections are coated with electrically non-conducting materials such that they are isolated from each other.

FIG. 3 illustrates a side view of the user interface system 102 (shown as a keypad in FIG. 1), in accordance with an embodiment of the present invention. The interface 202 is attached on top of the reservoir 204. The reservoir 204 stores the electrorheological fluid 206 and includes the source 208 (or electrodes). One end of the reservoir 204 is connected to the handle 216. The other end of the reservoir 204 and/or the interface 202 can be connected to the enclosure 212 through the strip 218. The enclosure 212 can enclose the interface 202 and the reservoir 204. In an embodiment, the reservoir 204 is enclosed in the reservoir enclosure 214. The enclosure 212 also includes the spring 302 that enables coiling of the reservoir 204 in the enclosure 212 when the electric field is removed from the electrorheological fluid 206. It should be noted that though the spring 302 as a coil spring, it will be understood by a person ordinarily skilled in the spring 302 can be any other type of spring as well. In other words, when a portable power unit 210, such as a portable battery, is disconnected from the electrorheological fluid 206, the physical state of the electrorheological fluid 206 changes to a liquid state. Thus the interface 202 becomes flexible. Thereafter, the spring 302 exerts a pulling force on the reservoir 204, enabling coiling of the reservoir 204 back in the enclosure 212.

In an example, the user interface system 102 may be used as a keyboard for an on-board computer in an automobile. In another example, the interface 202 is keypad of a mobile telephone. In yet another example, the interface 202 is display screen of a mobile telephone or a computer. The enclosure 212, enclosing the interface 202, and the reservoir 204 may be fitted in the dashboard. When the on-board computer is required by a user, the interface 202 can be pulled out by the user. Further, power supply is provided to the electrorheological fluid 206, making the interface 202 rigid. After use, the power supply is switched off, making the interface 202 flexible again. Thereafter, the spring 302 coils the interface 202 back in the enclosure 212.

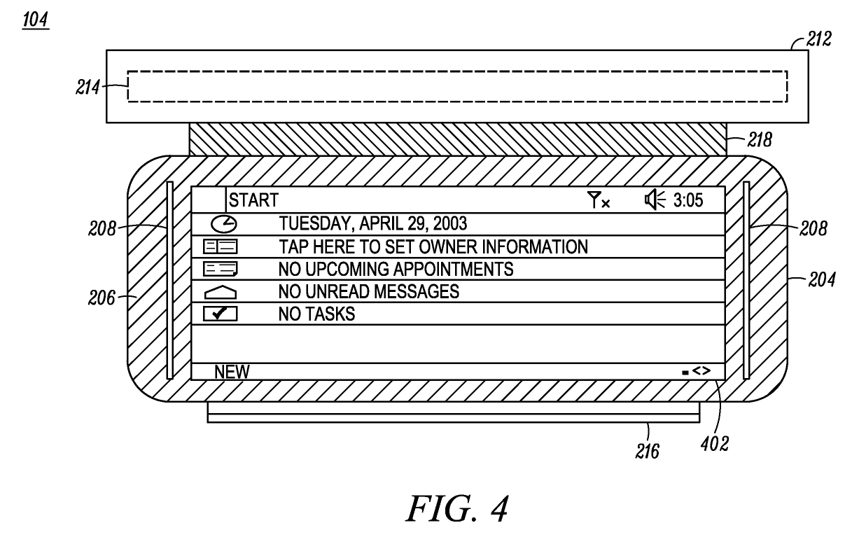

FIG. 4 illustrates a front view of the user interface system 104 (shown as a display in FIG. 1), in accordance with an embodiment of the present invention. In this embodiment, an interface 402 is a scrollable E paper. The E paper enables the text to be re-written on it. Further, it can be used as a display of an electronic device. In an embodiment, the E paper is made of flexible and scrollable material. The other details of the display are similar to that of the keypad, described in FIGS. 2 and 3.

In another embodiment, the user interface system 104 can be a work surface that can be used as a support for writing or for other purposes. Such a user interface system is specifically suitable for the use in workshops.

In yet another embodiment, the user interface system 104 can be used in safety equipments such as jackets, which can harden on demand, to provide extra safety to security personnel.

In yet another embodiment, the user interface system 104 can act as a divider that can be used to partition two sections of an enclosed space, for example, in an automobile, partitioning the driver's seat from the back seat.

In yet another embodiment, the user interface system 104 can be a windscreen of an automobile. The windscreen can be made active when protection is required, and can be coiled and made inactive when not in use. Further, the user interface system 104 can be used as the bumper and/or the engine cover. The bumper can be used as side protection of side doors of a vehicle. The bumper may collapse partially in an event of an accident, in an attempt to prevent injuries to a pedestrian.

It will be apparent to a person ordinarily skilled in the art that the concept of the change in the physical state of the electrorheological fluid 206, described above, can be applied for various other applications such as folding chairs, curtains, and so forth.

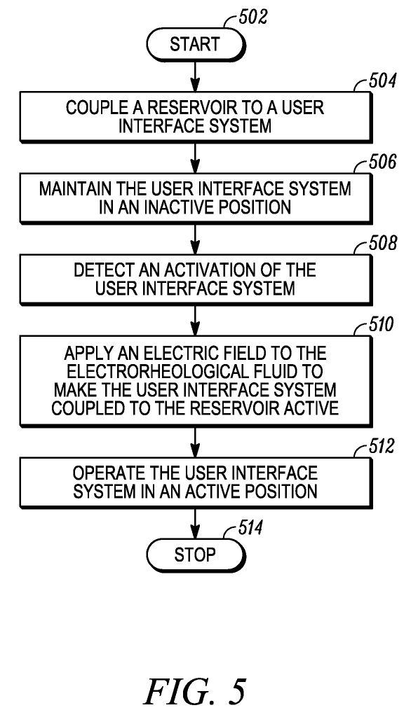

FIG. 5 is a flow diagram illustrating a method for operating the user interface system 102 (shown as a keypad in FIG. 1), in accordance with an embodiment of the present invention. It should be noted that though the flow diagram is described with reference to the user interface system 102, the flow diagram can be implemented with any other suitable embodiment of the invention as well. After initiating the process at step 502, the reservoir 204 is coupled to the user interface system 102 at step 504. The reservoir 204 can store the electrorheological fluid 206. In an embodiment, the reservoir 204 includes a flexible frame surrounding the interface 202. At step 506, the user interface system 102 is maintained in an inactive position. In the inactive position, the interface 202 of the user interface system 102 can be enclosed in the enclosure 212. In an embodiment, the interface 202 is coiled in the enclosure 212. The spring 302 enables coiling of the reservoir 204 and/or the interface 202.

At step 508, an activation of the user interface system 102 is detected. In other words, a user can pull out the coiled interface 202 and the reservoir 204 from the enclosure 212 by pulling the handle 216.

At step 510, an electric field is applied to the electrorheological fluid 206. This changes the physical state of the electrorheological fluid 206, stored in the reservoir 204, to a semi-solid (or solid) state. In an embodiment, the flexible frame surrounding the interface 202 becomes semi-solid (or solid) when the electrorheological fluid 206 becomes semi-solid (or solid). As a result, the interface 202, coupled to the reservoir 204, becomes rigid. At step 512, the interface 202 is operated in an active position. Thereafter, the process terminates at step 514.

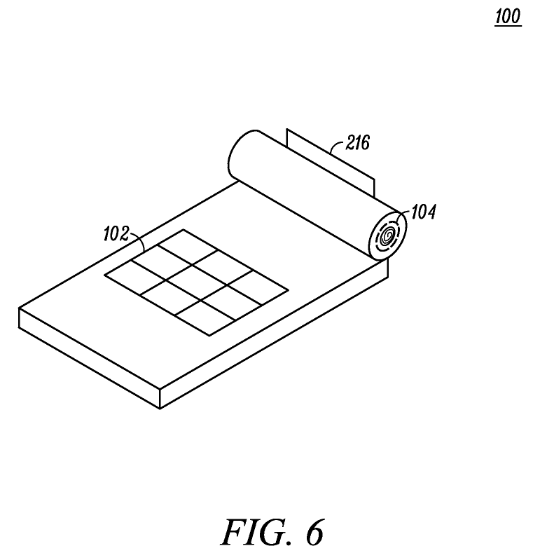

FIG. 6 illustrates a rolled-up view of the portable electronic device 100 including a user interface system 104 comprising a keypad 102, in accordance with an embodiment of the present invention. The user interface system 104 is shown to be rolled in an enclosure when the portable electronic device 100 is not in use. The user interface system 104 can be pulled out from the enclosure 104 using the handle 216.

Various embodiments, as described above, provide a user interface system. The user interface system enables a user to enclose the interface in an enclosure, when not in use. Further, the user can enclose the interface conveniently and quickly. Moreover, the user interface system occupies the minimum amount of workspace and is easy to carry as well. The user interface system is lightweight, portable and easy to handle while traveling.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims as issued.

What is claimed is:

1. A user interface system comprising:
an interface comprising a flexible material, the interface has an active position and an inactive position;
a reservoir coupled to the interface, wherein the reservoir stores an electrorheological fluid; and
a source coupled to the reservoir, wherein the source apply an electric field to the electrorheological fluid when the interface is in the active position.

2. A user interface system as claimed in claim 1, wherein the interface is selected from the group comprising a keyboard, a display, an electronic paper, a key matrix, and a work surface.

3. A user interface system as claimed in claim 1, wherein the reservoir is on of a flexible bag and a flexible plastic frame.

4. A user interface system as claimed in claim 1, wherein the flexible material comprises a rollable material, and further wherein the active position comprises a rolled-out position and the inactive position comprises a rolled-up position.

5. A user interface system as claimed in claim 1 further comprising:
an enclosure coupled to the interface, wherein the enclosure stores the interface when the interface is in the inactive position.

6. A user interface system as claimed in claim 1, wherein the electrorheological fluid is adapted to stiffen into a semi-solid state when subjected to the electric field.

7. A user interface system as claimed in claim 6, wherein the electrorheological fluid is coupled to the interface such that the interface stiffens into a semi-solid state when the electrorheological fluid stiffens into a semi-solid.

8. A user interface system as claimed in claim 6, wherein the reservoir comprises a flexible frame surrounding the interface, and further wherein the flexible frame stiffens into a semi-solid state when the electrorheological fluid stiffens into the semi-solid state to create a rigidity of the interface.

9. A user interface system as claimed in claim 1, wherein the source comprises a plurality of electrodes for applying the electric field to the electrorheological fluid.

10. A user interface system as claimed in claim 1 further comprising a portable power unit, wherein the portable power unit supplies electrical power to at least one of the source and the interface.

11. A user interface system as claimed in claim 1 further comprising a reservoir enclosure for storing the reservoir when the interface is in the inactive position.

12. A user interface as claimed in claim 11, wherein the reservoir is coiled up into the reservoir enclosure, and further wherein the reservoir enclosure comprises a spring for enabling coiling of the reservoir.

13. A user interface as claimed in claim 12 further comprising a handle connected to the reservoir, wherein the handle facilitates uncoiling of the reservoir.

14. A user interface as claimed in claim 11, wherein the source comprises a strip having electrically conducting sections, wherein the strip is attached to at least one of the reservoir enclosure, the reservoir, and the interface.

15. A method of operating a user interface system comprised of a flexible material, the method comprising the steps of:
coupling a reservoir to the user interface system, wherein the reservoir stores an electrorheological fluid;
maintaining the user interface system in an inactive position;
detecting an activation of the user interface system;
applying an electric field to the electrorheological fluid to cause the electrorheological fluid to become semi-solid; and
operating the user interface system in an active position.

16. A method of operating the user interface system as claimed in claim 15 further comprising the step of:
causing the user interface system to stiffen into a semi-solid when the electrorheological fluid stiffens into a semi-solid prior to the operating step.

17. A method of operating the user interface system as claimed in claim 15, wherein the reservoir comprises a flexible frame surrounding the user interface system, the method further comprising the steps of:
causing the flexible frame to stiffen into a semi-solid when the electrorheological fluid stiffens into a semi-solid state; and
using the stiffened flexible frame to create a rigidity of the user interface system prior to the operating step.
